(19) United States
(12) Patent Application Publication
(10) Pub. No.: US 2011/0035588 A1
(43) Pub. Date: Feb. 10, 2011

(54) Encoding Method and Device for Securing a Counter Meter Reading Against Subsequential Manipulations, an Inspection Method and Device for Verifying the Authenticity a Counter Meter Reading

(76) Inventors: Markus Dichtl, Munchen (DE); Erwin Hess, Ottobrunn (DE); Bernd Meyer, Munchen (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/922,823

(22) PCT Filed: Jun. 22, 2006
(86) PCT No.: PCT/EP2006/063446

§ 371 Date: Sep. 23, 2008

(30) Foreign Application Priority Data
Jun. 30, 2005 (DE) 10 2005 030 657.8

(51) Int. Cl. H04L 9/32; G06F 21/24

(52) U.S. Cl. 713/168; 726/26; 713/189

(57) ABSTRACT

The invention relates to an encoding method for identifying a subsequential manipulation of a counter meter reading consisting, when the counter reading is increased or decreased, in activating the computation of a new encoded meter reading and in calculating a new encoded meter reading by applying a forward chain one-way function to the encoded meter reading, wherein a complex variable domain of said forward chain one-way function is included into the antecedent domain thereof. The invention also relates to a method for verifying the authenticity of a counter meter reading consisting in subtracting test meter readings based on the meter reading for obtaining the number of tests, in producing an encoded test meter reading by applying the chain one-way function to the encoded meter reading, in applying the chain one-way function with the number of tests and in comparing the test meter reading with the final encoded meter reading and, if the test meter reading defers from the final encoded meter reading, a negative status signal is emitted. An encoding system for carrying out said encoding method and a verification system for carrying out the verification method are also disclosed.

Encoding method and encoding device for securing a counter reading of a counting unit against subsequent manipulation, and also verification method and verification device for verifying the authenticity of a counter reading of a counting unit

The invention relates to an encoding method in accordance with the preamble of claim 1 and a verification method for verifying the authenticity in accordance with the preamble of claim 10. In addition the invention relates to an encoding device in accordance with the preamble of claim 17 and a verification device in accordance with the preamble of claim 25.

Present-day counting devices, such as the odometer in an automobile or energy consumption meters for example, are susceptible to manipulation of the counter reading. This problem applies equally to mechanical and electronic counters.

In the case of an odometer in an automobile, the value of the automobile is increased by subsequently reducing the kilometer reading. With regard to leasing contracts, the leasing costs are reduced by means of such manipulation. Even though mechanisms capable of detecting such manipulation of the kilometer reading are used in some luxury class modern automobiles, it does nevertheless appear to be possible at the present time to change the kilometer reading on the majority of automobiles in such a manner that a specialist workshop is unable to detect this action.

Protection against manipulation is thus known for example whereby such manipulation is rendered more difficult through storage of the current kilometer reading at different storage locations and/or in a plurality of electronic control units in an automobile. This is because all storage locations need to be known in order to allow manipulation.

A further approach offering protection against manipulation actions can be implemented in that in the case of a write access to a storage area in which the current kilometer reading is to be stored said storage area is protected by an authentication method. In this situation, some secret information, a password or a key for example, is stored inside the vehicle. This approach fails amongst other things due to the fact that there is currently no physically secure storage area present in an automobile for the secure storage of secret information.

The document DE 101 13 317 A1 describes a method for the detection of errors when reading data out of a storage area. To this end, when the data is stored a check sum is generated by summing individual data words from the data and from this check sum a check word is generated by means of a predefined algebraic operation. When the stored data is read, a check sum is formed by summing the data words read and from this check sum a check word is likewise generated by means of the predefined algebraic function. This check word generated during reading is compared with the associated check word generated during storing, whereby an error is detected in the stored data in the event of any discrepancy between the two check words.

The object of the invention is to set down a method for securing a counter reading of a counting unit against subsequent manipulation, which can be implemented in a simple and cost-effective manner.

This object is achieved on the basis of the encoding method in accordance with the preamble of claim 1 by its characterizing features and also on the basis of the verification method in accordance with the preamble of claim 10 by its characterizing features. In addition, this object is achieved on the basis of the encoding device in accordance with the preamble of claim 17 by its characterizing features and also on the basis of the verification device in accordance with claim 25 by its characterizing features.

The invention relates to an encoding method for securing a counter reading of a counting unit against subsequent manipulation consisting, when the counter reading is incremented or decremented by one count unit, in activating the calculation of a new encoded counter reading and determining the new encoded counter reading by applying a forward chained one-way function to an encoded counter reading, whereby a range of the forward chained one-way function is contained in the domain of the forward chained one-way function.

By using the encoding method according to the invention it is possible to detect almost any subsequent manipulation to an earlier value because the encoded counter reading associated with the earlier counter reading needs to be set at the same time. As a result of the forward chained one-way function generation of the new encoded counter reading can be performed in a simple manner but a reversal of this processing step cannot be implemented in practical terms. The encoding method according to the invention thus prevents any subsequent manipulation of the counter reading whilst being simultaneously simple to manage.

By preference, the forward chained one-way function is selected from a set of available forward chained one-way functions. As a result, manipulation of the counter reading is made more difficult and security is thus increased. Furthermore, manipulation is made yet more difficult by the random selection of the forward chained one-way function.

If preferably before the counter reading is incremented or decremented for a first time the counter reading is preset to an initial counter reading and/or the encoded counter reading is preset to an encoded initial counter reading, whereby the encoded initial counter reading is selected from the domain of the forward chained one-way function, then the counter reading is additionally secured against manipulation. This is because as a result of the particularly random selection of the encoded initial counter reading any transfer of counter readings and encoded counter readings for one combined odometer from another combined odometer can be detected as manipulation.

In an extension of the method according to the invention, the encoded initial counter reading is generated as a function of some personalized information. Manipulation is thus made more difficult, for example, because the personalized information for example needs to be known in order to ascertain the encoded initial counter reading.

In a variant of the encoding method according to the invention, by applying the forward chained one-way function to the encoded initial counter reading an encoded final counter reading is generated for verifying the authenticity of the counter reading, whereby the forward chained one-way function is applied c times. Manipulation of the counter reading is made more difficult by this means because it is almost impossible to ascertain the encoded initial counter reading from the encoded final counter reading and to use it to generate a new encoded counter reading. Furthermore, the encoded final counter reading can advantageously be stored in unencrypted form. In this way it is possible both to reduce the resource requirement for managing the encoded final counter reading and also to avoid costs for a secure storage module for storing the encoded final counter reading.

If, according to a further embodiment, some authentication information is additionally generated for the encoded final counter reading and/or the encoded initial counter reading by means of a cryptographic authentication method using a first cryptographic key, then a transfer of counter readings and encoded counter readings from one combined odometer to another combined odometer can be detected as manipulation. The security of the encoding method according to the invention is increased as a result.

If, according to a further development of the invention, some personalized information, particularly a chassis number as the personalized information, which can be uniquely assigned to the counting unit, or a device number of the counting unit, is preferably additionally used with regard to the cryptographic authentication method, then a further increase in the security of the encoding method according to the invention is achieved.

By preference, the encoded initial counter reading and/or the encoded final counter reading are encrypted by means of a cryptographic encryption method using a second cryptographic key. Herewith in a simple manner any manipulation can be made more difficult or excluded on account of the complexity of the cryptographic encryption method.

The present invention also relates to a verification method for verifying the authenticity of a counter reading of a counting unit, whereby an encoded counter reading is generated on the basis of a forward chained one-way function, in which a test counter reading is determined on the basis of the counter reading, whereby the test counter reading represents a frequency for incrementing or decrementing the counter reading of the counting unit, the encoded counter reading is analyzed using the test counter reading, a positive status signal is emitted if the analysis yields the result that the encoded counter reading has been generated as a result of the counter reading, or a negative status signal is emitted if the analysis yields the result that the encoded counter reading has not been generated as a result of the counter reading. With the aid of the verification method it is possible in a simple and reliable manner to ascertain the authenticity of the encoded counter reading or of the counter reading. The verification method has a lower level of complexity because only the counter reading and the encoded counter reading need to be taken into consideration in the verification process.

By preference, the test counter reading is generated through the counter reading or by subtracting the initial counter reading from the counter reading or through a sum formed by subtracting the initial counter reading from the counter reading. The verification method according to the invention can thus be used with regard to incrementing or decrementing the counter reading.

In an extension of the verification method according to the invention, whereby the encoded counter reading and the encoded final counter reading are generated on the basis of a forward chained one-way function, a number of tests is generated by subtracting the test counter reading from the number, an encoded test counter reading is generated by applying the forward chained one-way function to the encoded counter reading, whereby the forward chained one-way function is applied with the number of tests t times, and the encoded test counter reading is compared with the encoded final counter reading, whereby in the event that the encoded test counter reading is not equal to the encoded final counter reading a negative status signal is emitted, or in the event that the encoded test counter reading is equal to the encoded final counter reading a positive status signal is emitted.

A verification of the authenticity of the counter reading in a manner which is simple and robust against manipulation is guaranteed by this verification method. Use of the encoded final counter reading means that it is almost impossible for an attacker to deduce the encoded initial counter reading, with the result that the verification result of this verification method exhibits a high level of reliability. Furthermore, this verification method is less complex and can be implemented and executed in a simple manner on a computer unit.

In an alternative variant, by applying the forward chained one-way function to the encoded initial counter reading an encoded test counter reading is preferably generated, whereby the forward chained one-way function is applied with the value of the test counter reading Xt times, the encoded test counter reading is compared with the encoded counter reading, whereby in the event that the encoded test counter reading is not equal to the encoded counter reading a negative status signal is emitted, or in the event that the encoded counter reading is equal to the encoded final counter reading a positive status signal is emitted. This variant of the verification method according to the invention is characterized by a low level of complexity and high level of reliability against manipulation. In this situation, only the encoded initial counter reading needs to be kept secret in order to prevent an attacker from being able to produce a new encoded counter reading on the basis of the encoded initial counter reading.

In one extension, the authenticity of the encoded final counter reading and/or of the encoded initial counter reading is preferably verified by means of a cryptographic authentication verification method using a first cryptographic verification key and some authentication information. With the aid of the authentication information it is possible to detect any manipulation of the encoded final counter reading or of the encoded initial counter reading in a simple and reliable manner. Any manipulation can be easily detected particularly through the use of personalized information because this can be associated solely with one person and/or one device, such as an odometer for example. The reliability of the verification method is thus further increased.

If furthermore in the case of the cryptographic authentication verification method some personalized information, particularly a chassis number as the personalized information, which can be uniquely assigned to the counting unit, or a device number of the counting unit, is additionally used, then a further increase in the security of the verification method according to the invention is achieved.

In an alternative extension, an encrypted encoded initial counter reading and/or an encrypted encoded final counter reading are decrypted using a second cryptographic verification key into the encoded initial counter reading or the encoded final counter reading respectively prior to executing the verification method. In this way, relevant counter readings are only available to an attacker in encrypted form. Any manipulation is thereby made more difficult and the security of the verification method according to the invention is thus significantly increased.

The invention furthermore relates to an encoding device for executing an encoding method for securing a counter reading of a counting unit against any subsequent manipulation, comprising a cryptographic counting unit for calculating a new encoded counter reading when the counter reading is incremented or decremented by one count unit by applying a forward chained one-way function to an encoded counter reading, whereby a range of the forward chained one-way function is contained in the domain of the forward chained one-way function. By this means, the encoding method according to the invention can be executed in a simple and cost-effective manner.

If by preference a processing module with a storage element is used for storing the encoded counter reading and an activation element for activating the calculation of the new encoded counter reading, and a function module with a forward chained one-way function for calculating the new encoded counter reading from the encoded counter reading, then the encoding method according to the invention can be implemented cost-effectively with a small number of elements. Furthermore, costs can be reduced if standard elements are used for the storage element and the forward chained one-way function.

In an alternative extension, the encoded counter reading is preset to an encoded initial counter reading by the processing module, with the result that any manipulation of the encoded counter can be detected more easily.

Furthermore, the encoding device includes a determination module for generating an encoded final counter reading by applying the forward chained one-way function to an encoded initial counter reading, whereby the forward chained one-way function is applied c times. The encoded final counter reading can be created in a simple manner as a result.

The encoding device preferably includes an authentication module for creating authentication information for the encoded final counter reading and/or the encoded initial counter reading using a first cryptographic key. With the aid of the authentication information any manipulation can be more easily detected.

The authentication module is preferably configured such that in the case of the cryptographic authentication method some personalized information, particularly a chassis number as the personalized information, which can be uniquely assigned to the counting unit, or a device number of the counting unit, is additionally used. Any manipulation can thus be made more difficult and the reliability of the encoding device thereby additionally increased.

In an extension of the encoding device according to the invention, this includes an encryption module for encrypting the encoded final counter reading and/or the encoded initial counter reading using a second cryptographic key into an encrypted encoded final counter reading or an encrypted encoded initial counter reading respectively. The risk of manipulation of the counter reading can thereby be further reduced, whereby the encryption module can in particular be implemented by means of a cost-effective standard module.

In a further development of the invention, the encoding device is used in an odometer device, particularly in an automobile, and/or in a consumption metering facility, particularly for registering electricity, gas or water consumption. By this means, manipulative actions are prevented in sectors in which any manipulation may cause considerable economic damage.

In addition, the invention relates to a verification device for executing a verification method for verifying the authenticity of a counter reading of a counting unit, comprising a verification module for analyzing the encoded counter reading on the basis of a test counter reading and for emitting a positive status signal if the analysis yields the result that the encoded counter reading has been generated as a result of the counter reading, or for emitting a negative status signal if the analysis yields the result that the encoded counter reading has not been produced as a result of the counter reading, whereby the test counter reading represents a frequency for incrementing or decrementing the counter reading of the counting unit. The verification method according to the invention can hereby be implemented in a simple manner.

The verification device preferably comprises a subtraction module for generating a number of tests by subtracting the test counter reading from a number, a generation module for generating an encoded test counter reading by applying the forward chained one-way function to the encoded counter reading, whereby the forward chained one-way function is applied with the number of tests t times, a comparison module for comparing the encoded test counter reading with the encoded final counter reading, whereby in the event that the encoded test counter reading is not equal to the encoded final counter reading a negative status signal is emitted, otherwise a positive status signal is emitted. By this means the verification method according to the invention can be implemented in such a manner as to achieve a high level of reliability when verifying the authenticity of the counter reading.

In an alternative development, the verification device includes a generation module for generating an encoded test counter reading by applying the forward chained one-way function to the encoded initial counter reading, whereby the forward chained one-way function is applied with the value of the test counter reading Xt times, a comparison module (VM) for comparing the encoded test counter reading with the encoded counter reading, whereby in the event that the encoded test counter reading is not equal to the encoded counter reading a negative status signal is emitted, otherwise a positive status signal is emitted. This alternative development is characterized by its cost-effective implementation because only a small number of modules need to be used. Furthermore, a high level of reliability against manipulation attacks is achieved.

In one extension, the verification device according to the invention includes an authentication verification module MAD for verifying the authenticity of the encoded final counter reading and/or of the encoded initial counter reading using a first cryptographic verification key and some authentication information. By this means a risk of manipulation is reduced, whereby a cost-effective implementation can be achieved by using standardized authentication verification modules.

By preference, the authentication verification module MAD is configured such that in the case of the cryptographic authentication verification method some personalized information, particularly a chassis number as the personalized information, which can be uniquely assigned to the counting unit, or a device number of the counting unit, is additionally used. Manipulation can thereby be made more difficult and the level of reliability of the verification device can thus be additionally increased.

If, in a further development, the verification device includes a decryption module for decrypting an encrypted encoded initial counter reading and/or an encrypted encoded final counter reading using a second cryptographic verification key into the encoded initial counter reading or the encoded final counter reading respectively prior to execution of the verification method, then the reliability achieved during verification of the authenticity of the counter reading can be further increased in a cost-effective manner whilst simultaneously maintaining a low level of complexity.

Furthermore, the verification device according to the invention is used in an odometer device, particularly in an automobile, and/or in a consumption metering facility, particularly for registering electricity, gas or water consumption. By this means, manipulative actions are prevented in sectors in which any manipulation can cause considerable economic damage.

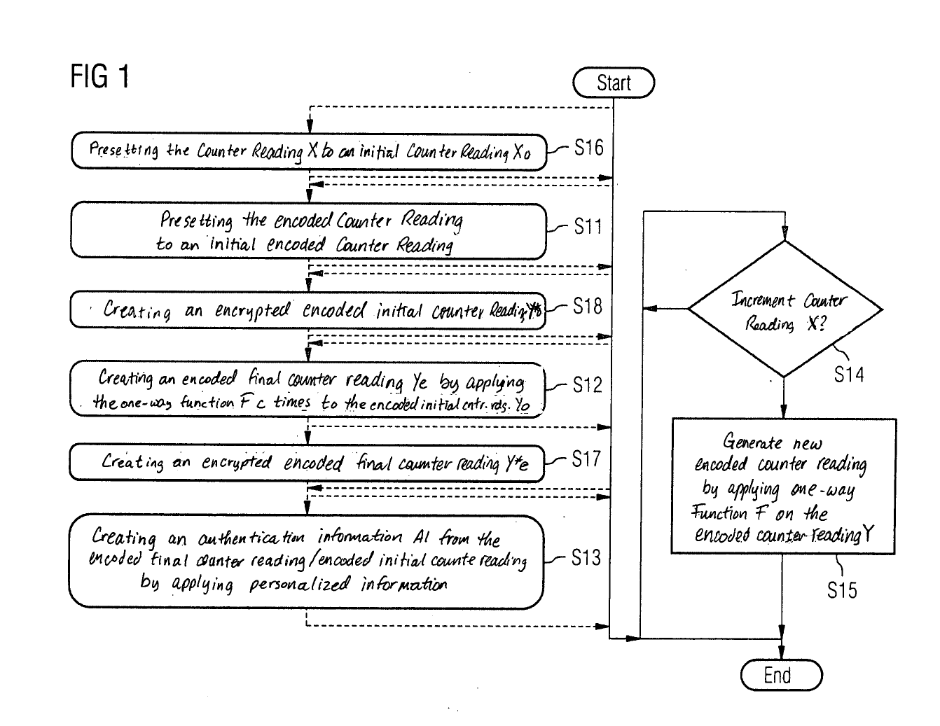

Further details and also advantages of the invention will be described in detail with reference to FIGS. 1 to 5. In the drawings:

FIG. 1 shows a flowchart of the encoding method according to the invention;

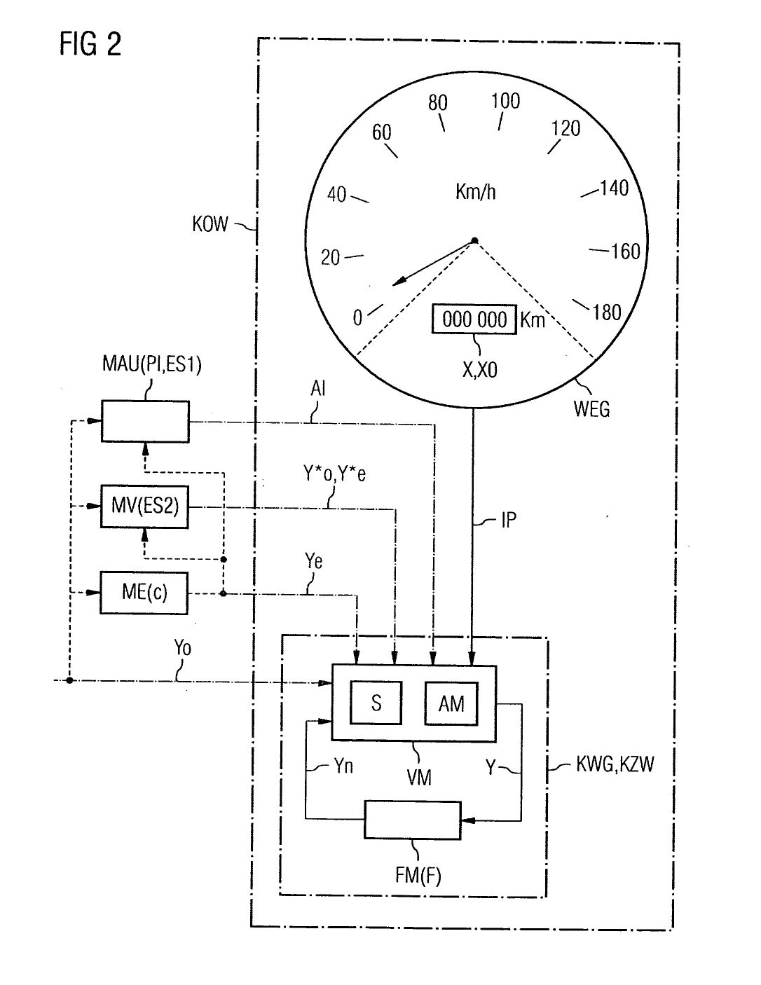

FIG. 2 shows an example for the structure of the encoding device according to the invention;

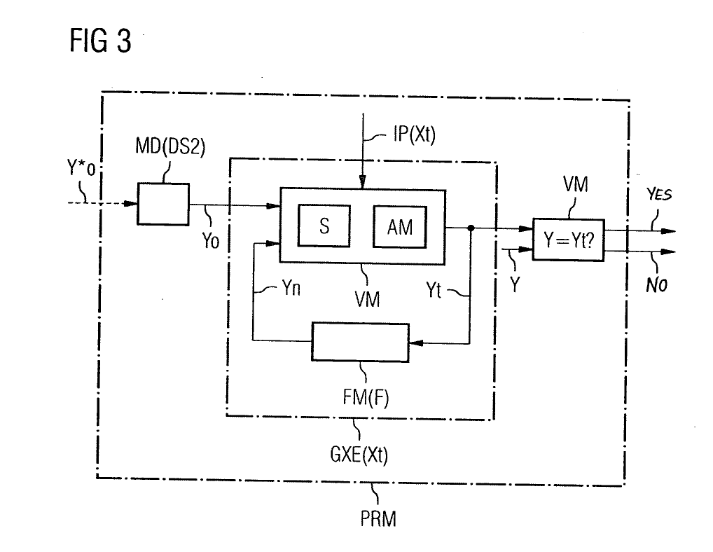

FIG. 3 shows an example for the structure of the verification method according to the invention for verifying the authenticity of a counter reading;

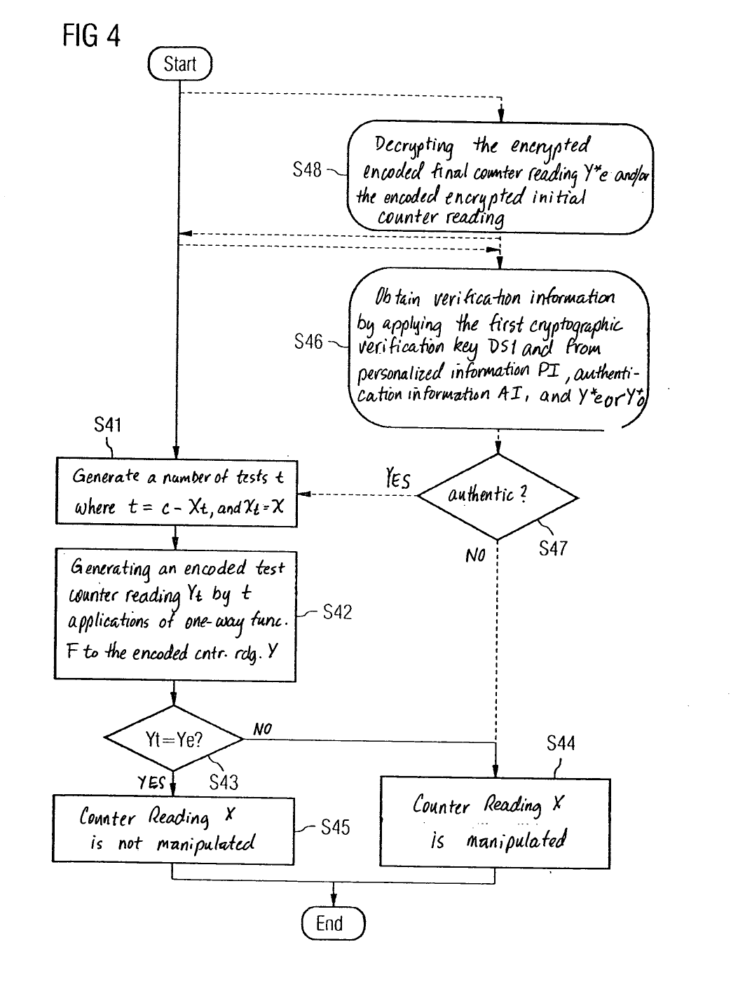

FIG. 4 shows a flowchart for the verification device according to the invention;

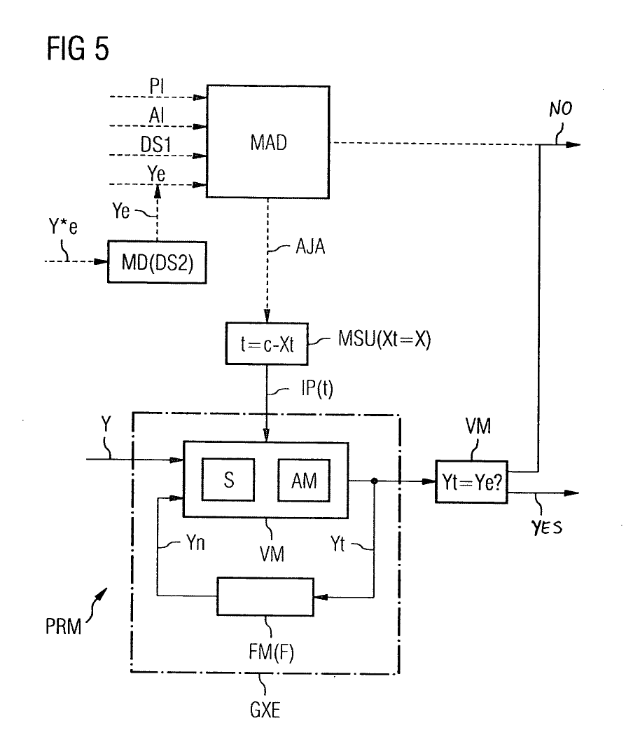

FIG. 5 shows a flowchart for the verification device according to the invention with verification of the authenticity.

Elements having the same function and mode of operation are identified by the same reference characters in FIGS. 1 to 5

The encoding method according to the invention will be described in detail in the following with reference to FIGS. 1 and 2, whereby an odometer WEG, in other words a counting unit, of an automobile for example, is protected against subsequent manipulation. To this end, the odometer WEG is supplemented by a cryptographic odometer KWG (=cryptographic counting unit KZW). The odometer WEG and the cryptographic odometer KWG are for example integrated in a combined odometer KOW. The encoding method according to the invention together with several extensions is represented in FIG. 1 in the form of a flowchart and in FIG. 2 in the form of a combined odometer KOW shown by way of example.

The odometer WEG shows for example a counter reading X in kilometers in addition to the current driving speed. When the combined odometer KOW is supplied, the counter reading X of the odometer WEG and an encoded counter reading of the cryptographic odometer KWG can each be preset to a specific initial value. The initial counter reading Xo is Xo=“0000000”, in other words X=Xo=“000000”, and the encoded counter reading Y is equal to an encoded initial counter reading Yo, in other words Y=Yo. When performing the presetting with the encoded initial counter reading Yo it is not possible to use any desired value, but the encoded initial counter reading Yo must be selected from the domain of a forward chained one-way function F. This domain and the forward chained one-way function F will be described in more detail later. The encoded counter reading Y can be stored in a storage element S of a processing module VM. In FIG. 1, presetting of the encoded counter reading Y is illustrated in step S11 and presetting of the counter reading X in step S16.

If the counter reading X of the odometer WEG is incremented by one count unit, for example from X=“0000000” to X=“0000001”, see query in step S14 in FIG. 1, then the cryptographic odometer KWG is activated, for example by means of a pulse signal IP, in order to calculate a new encoded counter reading Yn. This activation can be performed by an activation element AM which is situated for example in the processing module VM. To this end, the encoded counter reading Y is read out from the storage element S and delivered to a function module FM which executes the forward chained one-way function F, whereby the new encoded counter reading Yn is ascertained on the basis of the encoded counter reading Y. This therefore results in the new encoded counter reading Yn=F(Y). The new encoded counter reading Yn is stored in the storage element S and thus overwrites the preceding encoded counter reading Y. The encoded counter reading Y thus stands in the storage element S again. This method step is illustrated in step S15 in FIG. 1.

One-way functions are known for example from [1] pp. 8-9. In general these one-way functions exhibit the characteristic whereby a calculation of a new value from an old value can be performed in a simple manner from the computing standpoint, whereas the determination of an old value from a new value is extremely complex and this complexity increases greatly as a function of the word length of the value. At a word length of 128 bits or greater it is almost impossible from the computing standpoint to perform the determination of an old value from a new value. The one-way functions also have the characteristic that the range of the one-way function is contained in the domain of the one-way function. A known field of application for one-way functions is payment protocols, whereby these only use backward chained one-way functions. This is described in detail in the document [1] on pp. 396-397. In contrast, the forward chained one-way function F is used in the present invention.

In accordance with FIG. 3, a verification module PRM is used in order to verify the authenticity of the counter reading X of the odometer WEG. In this situation, a storage element S of a processing module VM is preset to the encoded initial counter reading Yo. Furthermore, a test counter reading Xt is formed for example by copying the value of the counter reading X. The test counter reading Xt indicates how often the counter reading X of the counting unit has been incremented or decremented. If the counter reading X was not zero prior to the first incrementation or decrementation, then the test counter reading Xt can be generated by Xt=X−Xo.

Subsequently, the pulse IP is stimulated Xt times in accordance with the test counter reading Xt. This pulse IP is received by an activation element AM of the processing module VM, whereby the activation element AM generates an encoded test counter reading Yt through Xt times application of the forward chained one-way function F to the encoded initial counter reading Yo. The forward chained one-way function F is situated in a function module FM and is executed by the latter. This relationship can be represented by the following equation:

$${Y}_{t} = \underbrace{F ( F ( … F ( Yo ) ) )}_{Xt \text{-} times} \qquad ( 1 )$$

The forward chained one-way function F and the storage element S are accommodated for example in a generator module GXE. Subsequently, the encoded test counter reading Yt is compared with the encoded counter reading Y of the cryptographic odometer KWG from FIG. 1 or 2 in a comparison module VM. If the encoded counter reading Y and the encoded test counter reading Yt are not identical, in other words Y≠Yt, then the combined odometer KOW or its counter reading X or Y has been manipulated. In this case a negative status signal NEIN can be emitted. If the verification reveals that no manipulation has occurred, in other words Y=Yt, then a positive status signal JA can be activated.

When using the encoded initial counter reading Yo the encoded initial counter reading Yo must remain secret. Otherwise a subsequent manipulation can be performed in such a manner that a counter reading X can be chosen as desired and by applying the forward chained one-way function F X times to the encoded initial counter reading Yo a manipulated encoded counter reading Y is generated. It is more secure to allocate each combined odometer KOW a separate, in particular randomly generated, encoded initial counter value Yo. This variant too requires that the relevant encoded initial counter values Yo be securely managed to protect against unauthorized access.

The coding and verification method according to the invention can also be used in the event of a decrementation of the counter reading X. If the initial counter reading is Xo=100 and the counter reading is X=80, then the test counter reading Xt can be generated by means of the following equation:

Xₜ=|X−Xo|=|80−100|=20 (2)

The remainder of the procedure for the verification method is analogous to the situation in which the counter reading X of the counting unit is incremented.

An extension of the method according to the invention is presented in the following which requires no secure safekeeping of the encoded initial counter reading Yo. Firstly, before the counter reading X is incremented or decremented for the first time a random encoded initial counter reading Yo is generated. This encoded initial counter reading Yo is written to the storage element S. In addition, in step S12 of FIG. 1 an encoded final counter reading Ye is created in such a manner that the forward chained one-way function F is applied a number c times to the encoded initial counter reading Yo. This encoded final counter reading Ye is stored for example in the storage element S of the cryptographic odometer KWG. In the following, each time the counter reading X is incremented or decremented the new encoded counter reading Yn is calculated by applying the forward chained one-way function F to the encoded counter reading Y.

In order to verify the authenticity of the counter reading X the verification method according to the invention is used which is illustrated in detail in FIG. 4. In this situation, a number of tests t=c−X is generated in step S41 by subtracting the current counter reading X from the number c. This takes place for example in the subtraction module MSU. Subsequently, an encoded test counter reading Yt is generated in step S42 by applying the forward chained one-way function F to the encoded counter reading Y, whereby the forward chained one-way function F is applied with the number of tests t t times. This can be represented mathematically as follows:

$${Y}_{t} = \underbrace{F ( F ( … F}_{t \text{-} times} ( Y ) ) ) = {F}^{t} ( Y ) \qquad ( 3 )$$

Finally, in step S43 the encoded test counter reading Yt is compared with the encoded final counter reading Ye; see comparison module VM. If this yields the result that the encoded test counter reading Yt is not equal to the encoded final counter reading Ye, in other words Ye≠Yt, then the counter reading X has been manipulated; see step S44. In this situation, the negative status signal NEIN can be emitted. Otherwise, step S45 yields the result that the counter reading X has not been manipulated, in other words Ye=Yt. This can be indicated by emitting the positive status signal JA.

This extension of the method according to the invention is characterized particularly in that neither the encoded final counter reading Ye nor the number c needs to be kept secret. Since it is as good as impossible to ascertain the encoded initial counter value Yo from the encoded final counter reading Ye on account of the characteristics of the forward chained one-way function F, no secrecy is required.

The described extension requires that the counter reading X does not exceed the number c. Therefore, when selecting the number c, the service life of the odometer WEG should be taken into consideration. Today's automobiles have an average service life of 150,000 km to 300,000 km for example. A maximum value for the counter reading X of 500,000 km and thus the number c=“500,000” should therefore suffice. In the case of commercial road vehicles, however, a significantly higher value does need to be set for the number c.

In a further embodiment of the encoding method according to the invention, the encoded final counter reading Ye and/or the encoded initial counter reading Yo can be encrypted by means of a cryptographic mechanism. To this end, an encrypted encoded final counter reading Y*e or an encrypted encoded initial counter reading Y*o is generated with the aid of a second cryptographic key ES2; see steps S17 and S18 from FIG. 1. In order to decrypt the encrypted encoded final counter reading Y*e and/or the encrypted encoded initial counter reading Y*o, a second cryptographic verification key DS2 is used. This can be seen in step S48 in FIG. 4. Manipulation is made more difficult by this encryption.

In a further variant, in accordance with FIGS. 1 and 2, the encoded final counter reading Ye or the encoded initial counter reading Yo can be protected against manipulation by means of a cryptographic mechanism for message authentication purposes, whereby personalized information PI can additionally be taken into consideration. It is possible to this end to use both symmetric mechanisms for calculating a message authentication code (MAC) and also asymmetric mechanisms for calculating electronic signatures. A secret first cryptographic key ES1 associated with the relevant cryptographic mechanism for determining the message authentication is known only to the manufacturer of the cryptographic odometer KWG. A serial number of the cryptographic odometer KWG and/or the chassis number of an automobile including the cryptographic odometer KWG, for example, is used as the personalized information PI. In this situation, the authentication information AI is generated as follows for example, taking into consideration an authentication method using a first cryptographic key ES1, the encoded final counter reading Ye and the personalized information PI:

AI=MAU(Ye,ES1,PI)

In this situation the reference character MAU describes an authentication module MAU for generating the authentication information AI. This step is illustrated in S13 in FIG. 1.

With regard to this variant according to the invention, in order to verify the authenticity of the counter reading X verification information is for example obtained in accordance with FIG. 4 steps S46 and S47 by means of an authentication verification method from the encoded final counter reading Ye, the authentication information AI, a first cryptographic verification key DS1 and the personalized information PI. This verification information indicates whether the encoded final counter reading Ye is authentic. In FIG. 5 these steps S46 and S47 are implemented in the authentication verification module MAD.

In the event of failure to verify authenticity, step S44 follows which indicates that the counter reading X or the encoded final counter reading Ye has been manipulated. In this situation, the negative status signal NEIN can be emitted. Otherwise, the method continues with step S41. This step is identified in FIG. 5 by the reference character AJA. The use of personalized information PI guarantees that a simple transfer of a counter reading, an encoded counter reading and an encoded final counter reading Ye from a first to a second combined odometer cannot take place undetected.

The authenticity verification performed for the encoded final counter reading Ye can also be carried out for the encoded initial counter reading Yo.

In a further variant of the invention, selection of the encoded initial counter reading Yo can be made as a function of personalized information PI.

In an extension of the encoding and verification method according to the invention a separate, in particular randomly selected, forward chained one-way function F can be used for each combined odometer KOW. In this situation, it is necessary to take into consideration the fact that when the verification method is executed for verifying the authenticity of the counter reading X the relevant forward chained one-way function F associated with the combined odometer KOW is used.

In a variant of the method according to the invention the combined odometer KOW comprises solely the cryptographic odometer KWG (this is not illustrated graphically). The odometer WEG is not required in this situation because the counter reading X can be ascertained from the encoded counter reading Y. In order to obtain the currently valid counter reading X, the forward chained one-way function F is applied to the encoded counter reading Y as often as required until the encoded counter reading Y matches the encoded final counter reading Ye. In this situation, a repeat number W counts how often the forward chained one-way function F has been applied during this process. The current counter reading X is yielded as a result of subtracting the repeat number W from the number c, in other words X=c−W. With regard to this variant, however, it is necessary to ensure that the encoded counter reading Y valid prior to determination of the current counter reading X is retained. Otherwise, the encoded counter reading Y matches the final counter reading Ye and this variant would thus result in an incorrect mode of operation for the combined odometer KOW.

The inventive encoding method, verification method and the inventive encoding device and verification device have been represented with reference to an odometer for an automobile. The invention is not however restricted to only this field of application and any counting unit can be protected by the invention against manipulation. Further examples of fields of application are consumption measuring devices such as those for electricity, gas or gaming machines for example.

### REFERENCES

[1] A. Menezes, P. van Oorschot, S. Vanstone, “Handbook Of Applied Cryptography”, CRC Press, 1996

1.-31. (canceled)

32. An encoding method for securing a counter reading of a counting unit against subsequent manipulation, comprising the steps of:
when the counter reading is incremented or decremented by one count unit, activating the calculation of a new encoded counter reading,
wherein the new encoded counter reading is calculated by applying a forward chained one-way function to an encoded counter reading, a range of the forward chained one-way function being contained in a domain of the forward chained one-way function.

33. The encoding method as claimed in claim 32, wherein the forward chained one-way function is selected from a set of available forward chained one-way functions.

34. The encoding method as claimed in claim 32, further comprising the step of presetting the counter reading to an initial counter reading before the counter reading is incremented or decremented for a first time.

35. The encoding method as claimed in claim 32, further comprising the step of presetting the encoded counter reading to an encoded initial counter reading before the counter reading is incremented or decremented for a first time, the encoded initial counter reading being selected from the domain of the forward chained one-way function.

36. The encoding method as claimed in claim 35, wherein the encoded initial counter reading is generated as a function of personalized information.

37. The encoding method as claimed in claim 35, further comprising the step of generating an encoded final counter reading by applying the forward chained one-way function to the encoded initial counter reading a number c times for verifying the authenticity of the counter reading.

38. The encoding method as claimed in claim 35, further comprising the step of generating authentication information for the encoded initial counter reading by a cryptographic authentication method using a first cryptographic key.

39. The encoding method as claimed in claim 38, wherein the cryptographic authentication method uses personalized information which can be uniquely assigned to the counting unit, or a device number of the counting unit.

40. The encoding method as claimed in claim 38, wherein the counting unit is an odometer of a vehicle and wherein the cryptographic authentication method uses a chassis number of the vehicle.

41. The encoding method as claimed in claim 35, further comprising the step of encrypting the encoded initial counter reading by a cryptographic encryption method using a second cryptographic key.

42. A verification method for verifying the authenticity of a counter reading of a counting unit, wherein a new encoded counter reading is generated by applying a forward chained one-way function to the encoded counter reading each time the counter reading is incremented or decremented, the method comprising the steps of:
determining a test counter reading based on the counter reading, wherein the test counter reading indicates how often the counter reading of the counting unit has been incremented or decremented;
analyzing the encoded counter reading using the test counter reading; and
generating a positive status signal if the analysis yields the result that the encoded counter reading has been generated as a result of the counter reading, or a negative status signal if the analysis yields the result that the encoded counter reading has not been generated as a result of the counter reading.

43. The verification method as claimed in claim 42, wherein the test counter reading is generated using the counter reading or by subtracting the initial counter reading from the counter reading, or through a sum formed by subtracting the initial counter reading from the counter reading.

44. The verification method as claimed in claim 42, where an encoded final counter reading is generated by applying the forward chained one-way function a number c times to an encoded initial counter reading, the verification method further comprising the steps of:
generating a number of tests t by subtracting the test counter reading from the number c;
generating an encoded test counter reading by applying the forward chained one-way function t times to the encoded counter reading;
wherein the step of analyzing comprises comparing the encoded test counter reading with the encoded final counter reading, the negative status signal being generated when the encoded test counter reading is not equal to the encoded final counter reading, and the positive status signal being generated when the encoded test counter reading is equal to the encoded final counter reading.

45. The verification method as claimed in claim 42, further comprising the steps of:
generating an encoded test counter reading by applying the forward chained one-way function to an encoded initial counter reading, wherein the forward chained one-way function is applied a number of times equal to the value of the test counter reading,
wherein the step of analyzing includes comparing the encoded test counter reading with the encoded counter reading, wherein the negative status signal is generated when the encoded test counter reading is not equal to the encoded counter reading, an a positive status signal is generated when the encoded counter reading is equal to the encoded final counter reading.

46. The verification method as claimed in claim 45, wherein authentication information is generated for the encoded initial counter reading by a cryptographic authentication method using a first cryptographic key, the verification method comprising the steps of verifying the authenticity of the encoded initial counter reading by a cryptographic authentication verification method using a first cryptographic verification key and the authentication information.

47. The verification method as claimed in claim 46, wherein the cryptographic authentication method uses personalized information which can be uniquely assigned to the counting unit, or a device number of the counting unit.

48. The encoding method as claimed in claim 46, wherein the counting unit is an odometer of a vehicle and wherein the cryptographic authentication method uses a chassis number of the vehicle.

49. The verification method as claimed in claim 45, further comprising the step of decrypting an encrypted encoded initial counter reading using a second cryptographic verification key into at least one of the encoded initial counter reading, respectively, prior to executing the verification method.

50. An encoding device for executing an encoding method for securing a counter reading of a counting unit against any subsequent manipulation, comprising:
a cryptographic counting unit storing an encoded counter reading and executing a process including the steps of calculating a new encoded counter reading when the counter reading of the counting unit is incremented or decremented by one count unit by applying a forward chained one-way function to the stored encoded counter reading, wherein a range of the forward chained one-way function is contained in the domain of the forward chained one-way function.

51. The encoding device as claimed in claim 50, further comprising:
a processing module with a storage element for storing the encoded counter reading and an activation element activating the calculation of the new encoded counter reading when the counter reading is incremented or decremented; and
a function module processing the forward chained one-way function.

52. The encoding device as claimed in claim 51, wherein the processing module presets the encoded counter reading to an encoded initial counter reading.

53. The encoding device as claimed in claim 52, further comprising a determination module generating an encoded final counter reading by applying the forward chained one-way function to an encoded initial counter reading a number c times.

54. The encoding device as claimed in claim 52, further comprising an authentication module creating authentication information for the encoded initial counter reading using a first cryptographic key.

55. The encoding device as claimed in claim 54, wherein the authentication module is configured such that the cryptographic authentication method uses personalized information which can be uniquely assigned to the counting unit, or a device number of the counting unit.

56. The encoding device as claimed in claim 54, wherein the counting unit is an odometer of a vehicle and wherein the authentication module is configured such that the cryptographic authentication method uses a chassis number of the vehicle.

57. The encoding device as claimed in claim 52, further comprising an encryption module for encrypting the encoded initial counter reading using a second cryptographic key into an encrypted encoded initial counter reading.

58. The encoding device of claim 50, wherein the encoding device comprises an odometer device, a consumption meter registering electricity, gas or water consumption.

59. A verification device for executing a verification method for verifying the authenticity of a counter reading of a counting unit, comprising:
a verification module executing a process including the steps of analyzing an encoded counter reading on the basis of a test counter reading, generating a positive status signal if the analysis yields that the encoded counter reading has been generated as a result of the counter reading, and generating a negative status signal if the analysis yields that the encoded counter reading has not been produced as a result of the counter reading, wherein the test counter reading indicates how often the counter reading of the counting unit has been incremented or decremented.

60. The verification device as claimed in claim 59, further comprising:
a subtraction module generating a number of tests t by subtracting the test counter reading from a number c;
a generation module generating an encoded test counter reading by applying the forward chained one-way function t times to the encoded counter reading; and
a comparison module comparing the encoded test counter reading with the encoded final counter reading, wherein the negative status signal is generated when the encoded test counter reading is not equal to the encoded final counter reading, and a positive status signal is generated when the encoded test counter reading is equal to the encoded final counter reading.

61. The verification device as claimed in claim 59, further comprising:
a generation module generating an encoded test counter reading by applying the forward chained one-way function to an encoded initial counter reading, wherein the forward chained one-way function is applied a number of times equal to the test counter reading; and
a comparison module comparing the encoded test counter reading with the encoded counter reading, the negative status signal is generated when the encoded test counter reading is not equal to the encoded counter reading, and the a positive status signal is generated when the encoded test counter reading is equal to the encoded final counter reading.

62. The verification device as claimed in claim 59, further comprising an authentication verification module verifying the authenticity of at least one of an encoded final counter reading and an encoded initial counter reading with a cryptographic authentication verification method using a first cryptographic verification key and authentication information.

63. The verification device as claimed in claim 62, wherein the authentication verification module is configured such that the cryptographic authentication method uses personalized information which can be uniquely assigned to the counting unit, or a device number of the counting unit.

64. The verification device as claimed in claim 62, wherein the counting unit is an odometer of a vehicle and wherein the authentication module is configured such that the cryptographic authentication method uses a chassis number of the vehicle.

65. The verification device as claimed in claim 59, further comprising an encryption module for encrypting at least one of an encoded final counter reading and an encoded initial counter reading using a second cryptographic key into at least one of an encrypted encoded final counter reading and an encrypted encoded initial counter reading, respectively.

66. The verification device as claimed in claim 59, wherein the encoding device comprises an odometer device, a consumption meter registering electricity, gas or water consumption.
